(19) United States
(12) Patent Application Publication
(10) Pub. No.: US 2003/0157928 A1
(43) Pub. Date: Aug. 21, 2003

(54) Systems, methods, and apparatus for efficient transfer of information over wireless data links

(76) Inventor: Marc S. Phillips, San Diego, CA (US)

Correspondence Address: Qualcomm Incorporated, Patents Department, 5775 Morehouse Drive, San Diego, CA, 92121-1714, US

(21) Appl. No.: 10/080,340

(22) Filed: Feb. 21, 2002

(51) Int. Cl. H04Q 7/20

(52) U.S. Cl. 455/414; 455/450

(57) ABSTRACT

A method of data selection includes storing a set of presentation data items (PDIs) received over a first wireless data link, and receiving over a second wireless data link a presentation command. The first and second wireless data links may be carried over different channels, or over the same channel at different times. In response to the presentation command, and based on a presentation history, one or more of the stored PDIs is selected. In one application, the presentation command is received as part of a web page, and each PDI includes an image for presentation to a user engaged in online browsing.

### BACKGROUND

1. Field

The present invention relates generally to wireless data communications. More particularly, the present invention relates to a spectrum-efficient method for delivery of data items to a wireless device.

2. Background

As portable devices capable of supporting online activities become more widely available, applications for portable wireless connectivity are on the rise. Cellular telephones that offer functions such as web browsing and e-mail reception and transmission are becoming ubiquitous and in demand. As the online experience spreads from the desktop to these portable platforms, consumers expect to obtain a similar level of service in the new environment.

While the information-carrying capacities of wireless channels have increased to the point where online activities are feasible, the capacities of such channels are still limited, and peak-time network access is still in short supply. As the quality of the online experience is related to the quantity and size of the data items being transferred to support the online activity, the ability to transfer information efficiently across a wireless data link is becoming more important.

As in a wired online environment, it is desirable to include advertisements (e.g. banners) in web pages that are served to wireless users. For example, revenue generated by such advertisements may at least partially offset the cost of the online service to the provider. To be effective, an advertisement may include large data items such as images or sounds. The transmission of these items may consume large amounts of bandwidth, however, and consumers may not be satisfied with an online experience that includes long delays caused by downloading advertisements.

Additionally, consumers may not accept being charged for airtime used to download advertisements. Therefore, it may also be necessary to perform the complicated task of dividing the usage charges incurred in downloading each web page into charges that are due to the transmission of advertisements and charges that are billable to the user. A more efficient method for delivery of advertisements and related data items to a wireless online user is desired.

### SUMMARY

A method of data selection according to one embodiment of the invention includes storing a set of presentation data items (PDIs) that are received over a first wireless data link. Over a second wireless data link, a presentation command is received. In response to this presentation command, at least one of the PDIs is selected, and the selected item or items are retrieved. In some implementations, the second wireless data link is established over a different channel than the first wireless data link. In other implementations, the second wireless data link is established over the same channel as the first wireless data link but at a different time. Devices for wireless communications and methods for data transmission are also described.

### BRIEF DESCRIPTION OF THE DRAWINGS

FIG. 1 shows a flowchart for a method according to an embodiment of the invention.

FIG. 2 shows a flowchart for a method according to an embodiment of the invention.

FIG. 3 shows a flowchart for a method according to an embodiment of the invention.

FIG. 4 shows a flowchart for a method according to an embodiment of the invention.

FIG. 5 shows a block diagram of a presentation history 130a and a storage area 120a.

FIG. 6 shows a block diagram of a presentation history 130b and a storage area 120b.

FIG. 7 shows a block diagram of a presentation history 130c, a base marker 230c, and a storage area 120c.

FIG. 8 shows a block diagram for a device 100 according to an embodiment of the invention.

FIG. 9 shows a block diagram for an implementation 102 of a device 100 according to an embodiment of the invention.

FIG. 10 shows a block diagram for an implementation 104 of a device 100 according to an embodiment of the invention.

### DETAILED DESCRIPTION

The word “exemplary” is used exclusively herein to mean “serving as an example, instance, or illustration.” Any embodiment, arrangement, or application described herein as “exemplary” is not necessarily to be construed as preferred or advantageous over other embodiments, arrangements, or applications.

In a particular application of a method according to an embodiment of the invention, a set of advertisements (or portions thereof, such as text, image, or sound files) are received over a first wireless data link and stored. As web pages received over a second wireless data link are interpreted, stored advertisements are retrieved according to presentation commands in the web pages. The retrieved advertisements may then be provided to a display unit without having to download the advertisements together with other web page elements. The retrieved advertisements may then be presented to a user together with the other web page elements (for example, tables and/or text) within web pages received over the second wireless data link.

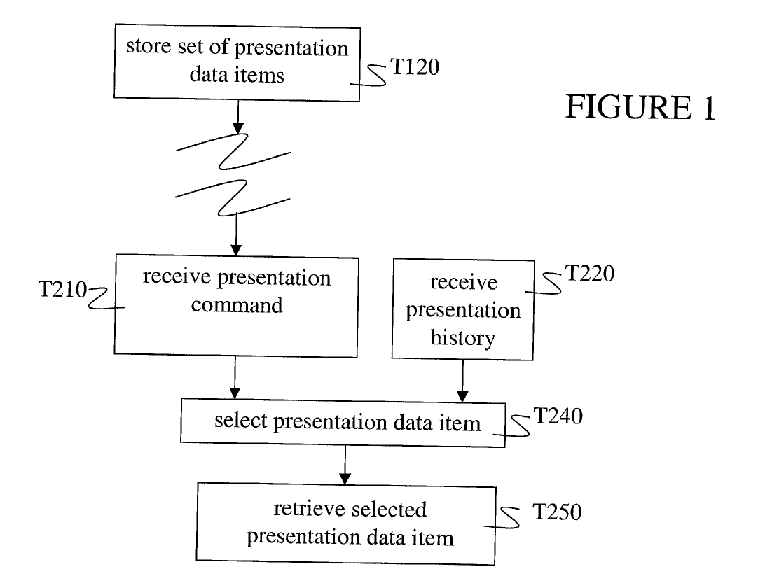

FIG. 1 shows a method according to an embodiment of the invention. Task T120 stores a set of presentation data items (PDIs) received over a first wireless data link. Over a second wireless data link, task T210 receives a presentation command. Task T220 receives a presentation history. In response to the presentation command and based on the presentation history, task T240 selects a PDI, and task T250 retrieves the selected item.

In an exemplary implementation of a method as shown in FIG. 1, each data item in the set of PDIs includes an image file. Each image file may be stored in an uncompressed format (e.g. a bitmap format). Alternatively, one or more of the image files may be stored in a compressed format using a scheme such as Lempel-Ziv, Lempel-Ziv-Walsh, discrete cosine transform (DCT), or wavelet compression [e.g. a format such as GIF (Graphics Interchange Format), animated GIF, PNG (Portable Network Graphics), TIFF (Tagged Image File Format), BMP (bitmap), or JPG/JPEG/JFIF (Joint Photographic Experts Group) or JPEG2000].

Each image file may be configured to have the same predetermined display size (in pixels horizontal by pixels vertical), or one or more of the image files may be configured to have a different display size. Similarly, each image file may occupy the same predetermined amount of storage area (e.g. in bytes), or one or more of the image files may have a different size. Each image file may have a header containing information such as file size, display size, and compression format. Alternatively, each image file may contain only image data, with other information such as file size, display size, and/or compression format being understood.

In another application, the set of presentation data files may include other files representing data such as text, haptics or other tactile information (such as activating a vibrating buzzer in the phone), and/or sound. For example, a data file may represent sound information in a format such as RIFF (Resource Interchange File Format), WAV (waveform data), MIDI (Musical Instrument Digital Interface), MPEG Layer 3 (MP3), or a linear prediction scheme such as CELP (code excited linear prediction) or QCELP (Qualcomm CELP). Other possible types of presentation data files include multimedia information represented in a format such as Shockwave Flash (SWF, specification available at http://www.openswf.org) and information encoded into a Java applet.

In an exemplary application, task T210 receives the presentation command as a part of a document. One example of a document that may be received in task T210 is a text file that contains source code based on a specification of a web page markup language or markup language subset such as the Hypertext Markup Language (HTML) or Handheld Markup Language (HDML) (as published on the Internet at www.w3.org or otherwise available from W3 at Massachusetts Institute of Technology/Laboratory for Computer Science, Cambridge, Mass.) or SGML (Standard Generalized Markup Language). When viewed using a web browser, such documents are commonly called ‘web pages.’ In another example, the presentation command is received as part of a Java applet or other executable code routine.

In a particular example, the presentation command is an attribute in a HTML document, such as a ‘src’ attribute of an IMG, EMBED, or BGSOUND element. A ‘src’ attribute contains a Uniform Resource Identifier (URI) that indicates the data item corresponding to the element, for example:

<IMG src=“data_item_URI”>.

Similar attributes may be found in documents that comply with at least a subset of a version of one or more other languages as well, including these examples:

XML (Extensible Markup Language) (specifications current to Nov. 21, 2001 and earlier available at www.w3.org or from W3 at Massachusetts Institute of Technology/Laboratory for Computer Science, Cambridge, Mass.);

WML (Wireless Markup Language) (specifications current to Nov. 21, 2001 available at www.wapforum.org).

Alternatively, the presentation command may be a ‘src’ property of a Javascript ‘Image’ object (Javascript 1.1 specification available online at http://home.netscape.com/eng/javascript/), for example:

var image1=new Image( );

image1.src=“data item_URI”;

In one implementation of a method as shown in FIG. 1, the first wireless data link is active over a wireless channel during a low-usage period. For example, the low-usage period may correspond to a time of day when off-peak billing rates are in effect. In such case, a wireless device may initiate a connection to the wireless network to establish the first wireless data link, and/or the network may initiate the connection. Alternatively, the wireless network may determine a low-usage period (and activate the first wireless datalink) upon detecting available network capacity.

The second wireless data link is active over the wireless channel when a user activates the device for use (e.g. to perform a session of web browsing, call origination or answering, game playing, or one or more similar interactive activities as may be supported by a device performing the method). In one such application, the user is prevented from activating the second wireless data link when the first wireless data link is active. In another application, activity on the first wireless data link is interrupted if the user activates the second wireless data link (e.g. during the low-usage period). In this case, activity on the first wireless data link may resume when the user terminates the second wireless data link and/or when the second wireless data link otherwise becomes inactive (e.g. after a period of user inactivity of predetermined length).

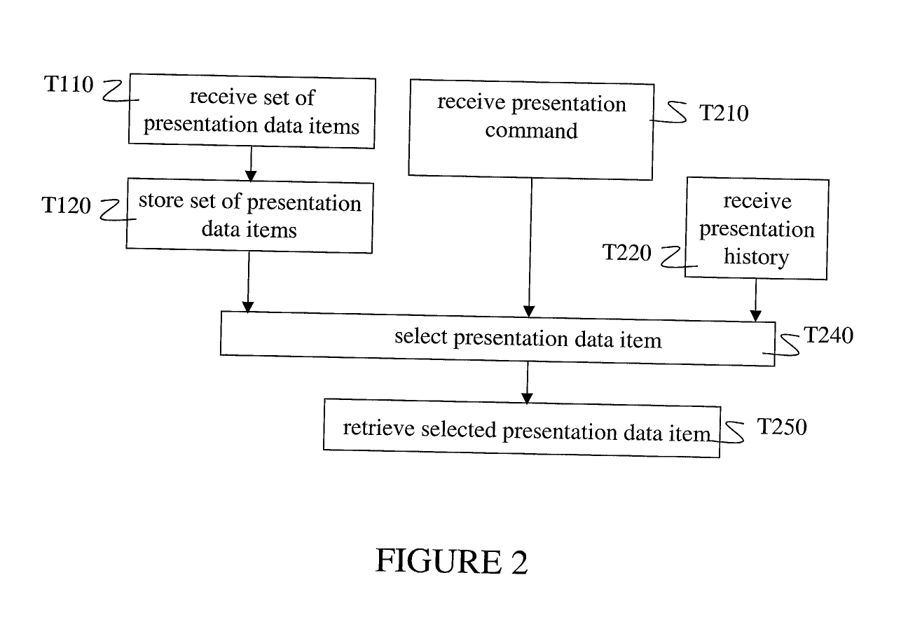

FIG. 2 shows a flowchart for a method according to an alternative implementation of the invention. Task T110 receives the set of PDIs over a first wireless data link. In this implementation, the first wireless data link is carried over a different wireless channel than the second wireless data link. The two different wireless channels may be separated using any of a variety of methods including the use of orthogonal frequency bands (as in a frequency-division multiple access or FDMA system), orthogonal series of time slots (as in a time-division multiple access or TDMA system), and/or in different code spaces (e.g. distinguished by different pseudonoise spreading codes and/or Walsh function codes as may be used in a code-division multiple access or CDMA system). Additionally, the two channels may be distinguished by their occurrence within disjoint time periods, with the first wireless data link and first wireless channel being terminated before the second wireless data link and second wireless channel are established. Additionally, the two channels may be distinguished through the use of different destination addresses or addressing schemes, such as broadcast, multicast, or unicast addressing. Or, the two channels may be distinguished through the use of different service option (SO) identifiers.

In one such implementation, PDIs may be transferred over one wireless channel at the same time that the second wireless data link is active over another wireless channel. In a system that complies with Interim Standard IS-95B (Telecommunications Industry Association (TIA/EIA), Arlington, Va.), for example, one of the two transmissions may be conducted over a fundamental channel while the other is conducted over a supplemental channel. Depending on the particular application and context, it may be desirable to transmit the PDIs at a lower data rate and transmit power (e.g. to minimize interference with other channels) or, alternatively, in bursts at a higher data rate and transmit power (e.g. to cover a wider geographical area).

In an application of a method as shown in FIG. 2, the first wireless link is carried over a type of channel that is reserved for traffic from a base station to a predetermined mobile unit. In another such application, the first wireless link is carried over a broadcast type of channel that may carry traffic from a base station to several or even all of the mobile devices on a wireless communications network such as a cellular telephone network. As discussed above with reference to FIG. 1, the first wireless data link may be active during a low-usage period and may even be restricted to such a period.

In some applications, task T210 may receive a presentation command that explicitly or exclusively identifies one or more PDIs in the stored set. For example, PDIs may be stored as files having unique filenames and/or directory paths, and the presentation command may include filename and/or path information to identify one or more particular stored PDIs.

In other applications, task T210 may receive a presentation command that indicates the use of one or more of the stored set of PDIs but does not directly identify a particular PDI. For example, the presentation command may be received as a tag (such as an attribute or property) within an HTML element or Javascript object as described above.

In at least some cases, the presentation command tag need not be valid within the relevant context (e.g. with respect to the HTML specification), although it may be desirable to configure such a tag so that a normal web browser will overlook it without attempting to interpret the tag and/or without indicating an error. For example, a typical IMG element may normally appear as follows:

<IMG src=“/Ads/WWW/vendor_{—}1.gif” width=“240” height=“120” alt=“Vendor 1” border=“0” name=“img4”>.

In this particular example, the attributes ‘src,’ ‘width,’ ‘height,’ ‘alt,’ ‘border,’ and ‘name’ have explicit values; the HTML specification provides for other attributes as well. A server transmitting a presentation command according to an embodiment of the invention may alter this IMG element as follows, so that the element includes a command tag (here, ‘LOCAL’) indicating presentation of a stored PDI:

<IMG src=“/Ads/WWW/vendor_{—}1.gif” width=“240” height=“120” alt=“Vendor 1” border=“0” name=“img4” LOCAL(vendor_type=1)>.

Such a server may be configured to serve the command tag regardless of the client. Alternatively, the server may be configured to serve the additional tag only to clients previously identified as wireless online users or users otherwise employing a browser enabled to interpret the tag.

In the particular example shown above, the command tag ‘LOCAL’ also includes information indicating a desired category of the PDI (i.e. ‘vendor_type=1’). Such categories may include subject matter (e.g. sports, beauty, consumer electronics, financial) and display size (e.g. small to large). As described below, the stored set of PDIs may be organized to permit retrieval according to such an indication.

As discussed above, a presentation command may include a Uniform Resource Identifier corresponding to a PDI that that is only available from a remote location or storage area (e.g. a remote web server). A web browser interpreting a ‘src’ attribute that includes a URI will normally issue a request directed to that URI. In another application of a method according to an embodiment of the invention, task T210 intercepts requests directed to a particular URI or to a range or set of URIs, and redirects the requests to PDIs that are available in local storage (within the wireless device). For example, task T210 may monitor outgoing HTTP requests (e.g. as produced by a browser interpreting the web page) and intercept those requests that satisfy a predetermined criterion. Such requests are then fulfilled using the PDI retrieved in response to the presentation command. In another such application, the redirection is performed during interpretation of the attribute.

The interception of a URI that corresponds to a PDI that that is only available from a remote storage location may occur either before or after the URI is provided to the browser. Where the URI is intercepted before it is presented to the browser, the URI is substituted by another that indicates a local storage location (stored in the memory of the wireless device) and provided to the browser. The wireless device may then include a small server that enables the browser to access the locally stored PDIs using a presentation command containing the substituted URI. In an alternate embodiment, the URI is intercepted after having been provided to the browser. When the browser requests the PDI using a URI that indicates a remote storage location, the request is fulfilled from a PDI stored locally without any contact with the remote storage location. Where URIs are substituted or redirected as described above, the browser need not support any special commands or command syntax outside of what is specified in a particular markup language specification. In other words, the browser can be an off-the-shelf implementation.

In at least some of these cases, the URI in the presentation command need not be a valid markup language command under a particular markup language specification. For example, the server may be configured to serve documents containing such URIs only to certain (e.g. wireless) clients. In such cases, the URI may include additional information (e.g. information indicating a desired category of the PDI). Alternatively, the server may be configured to serve the same document (or different documents having the same URIs) regardless of the identity of the client. In such cases, it may be desirable for the URI to be valid (e.g. to maintain compatibility of the document with other clients).

Also, a presentation command need not be a markup language command at all. For example, a wireless network may transmit a PDI to a wireless device during a first period, and then issue a presentation command during a second period. Both the initial transmission of the PDI and subsequent presentation command being accomplished using a protocol other than a markup language protocol, such as a protocol that is specific to wireless networks. The presentation command may be addressed directly to the wireless device, and may be independent from a browser running on that wireless device. This could allow the wireless network to transmit PDIs, which are generally much larger than the presentation commands, during a low-usage period. Later, the PDI can be displayed during a higher usage period by sending the smaller presentation command. As discussed herein, a PDI can be simultaneously transmitted to multiple wireless devices using a broadcast channel. Also, a presentation command can be sent using broadcast (to all wireless devices), multicast (to an identifiable subset of the wireless devices), or unicast (to a single wireless device) messaging. Also, a presentation command can be sent using broadcast, multicast, or unicast messaging.

Alternatively, a PDI can be sent to one or more wireless devices and presented without the wireless device receiving any presentation command at all. The PDI can be presented immediately, after a specified time period or upon some other event detected by the wireless device. For example, the wireless device could present the PDI upon receiving some user input such as pressing a key or while dialing a phone number. Additionally, the wireless device might present the PDI upon being powered on, awakened from a standby mode, or upon activated by opening a cover or flipping open a display. After such an event, the wireless device might also present various presentation data items continuously, switching PDIs periodically. The PDIs may be displayed in a fixed sequence or in a substantially random sequence. Additionally, the wireless device may maintain a presentation history of a group of PDIs such that the wireless device repeatedly cycles through the PDIs in the group. Or, the wireless device may use the presentation history to ensure that each PDI is presented only once, or that several PDIs are presented approximately the same number of times.

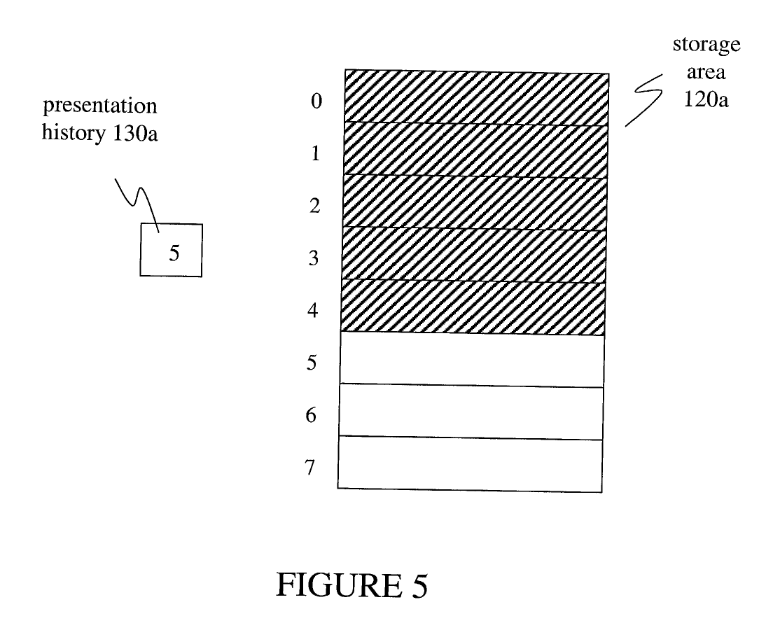

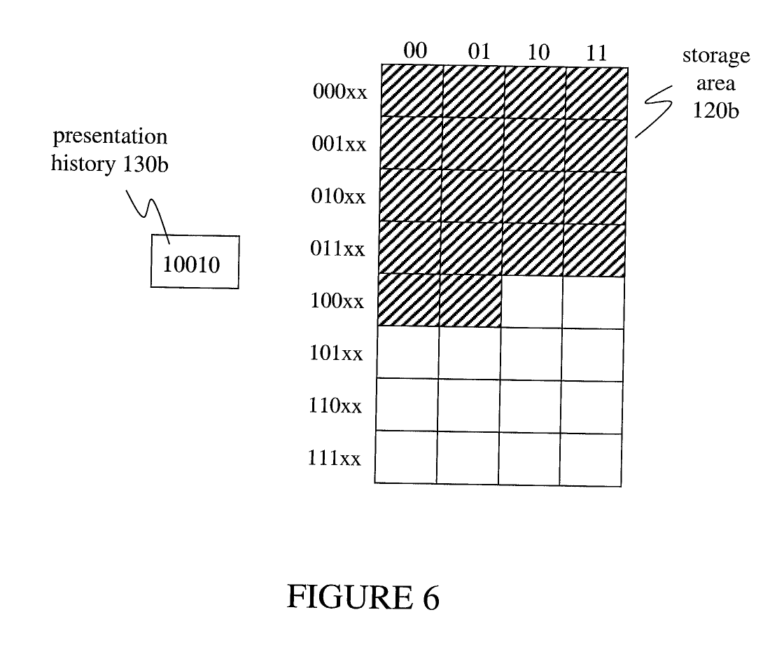

In one application, the set of PDIs is stored in a linear sequence. A presentation history (e.g. a marker or pointer) is initialized to indicate the first PDI in the set. In a method as shown in FIG. 1 or FIG. 2, task T220 receives the presentation history, and selection task T240 selects a PDI based on the presentation history. When a PDI is retrieved (e.g. in task T250), the presentation history is updated to indicate the next PDI in the set. FIG. 5 illustrates one such implementation of a storage area 120a in which the five shaded areas denote stored PDIs (or blocks of stored multi-block PDIs) and presentation history 130a points to the next available PDI (or PDI block). FIG. 6 illustrates a implementation of a storage area 120b and presentation history 130b in which the PDIs (or PDI blocks) are stored in a 4×8 array.

In a particular implementation, an action is triggered when the presentation history meets and/or passes beyond a predetermined threshold. For example, when the number of unretrieved PDIs falls below a predetermined minimum number, an action to obtain additional PDIs over the first wireless data link may be initiated. The threshold may be fixed or may vary depending on one or more factors such as the amount of storage available to store PDIs, the time of day, and a rate of use of PDIs.

In another application, the set of PDIs is stored in a circular queue (also called a ring buffer). The presentation history is initialized to indicate the first PDI in the set, and a second marker or pointer (a ‘base marker’) is initialized to indicate the last PDI in the set. When a PDI is retrieved, the presentation history is updated to indicate the next PDI in the set. In this case, an action (e.g. to obtain additional PDIs) may be triggered when the distance between the presentation history and the base marker meets and/or falls below a predetermined minimum number. When additional PDIs are received and added to the stored set (possibly including overwriting PDIs that have already been retrieved), the base marker is updated to indicate the last PDI in the current stored set.

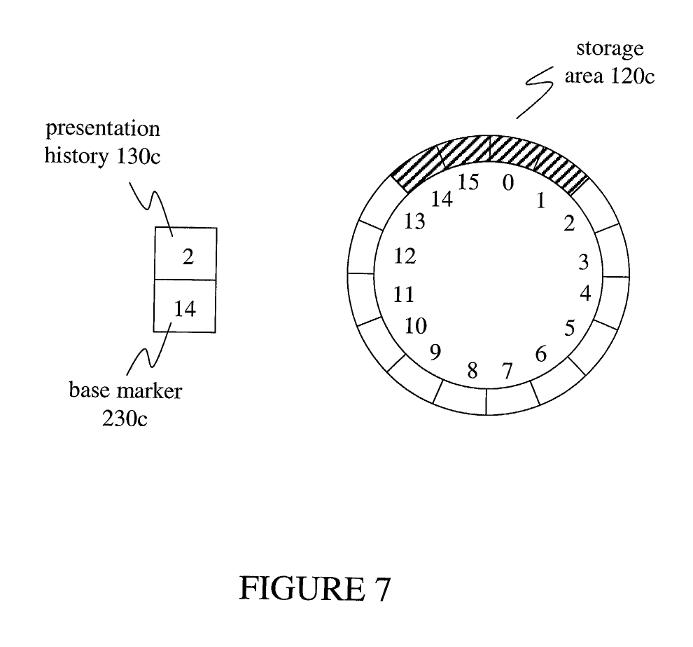

FIG. 7 illustrates one such implementation of a storage area 120c in which the four shaded areas denote stored PDIs (or blocks of stored multi-block PDIs), presentation history 130c points to the next available PDI (or PDI block), and base marker 230c points to the PDI (or PDI block) that follows the last PDI (or PDI block) in the set. In such case, storage of additional PDIs (e.g. prompted by a relation between the values of presentation history 130c and base marker 230c) would begin at PDI (PDI block) 14 and progress clockwise.

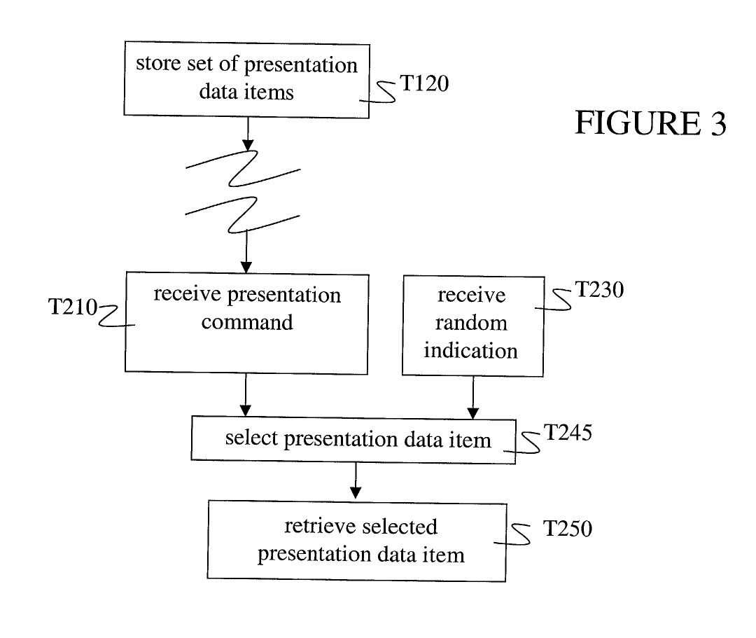

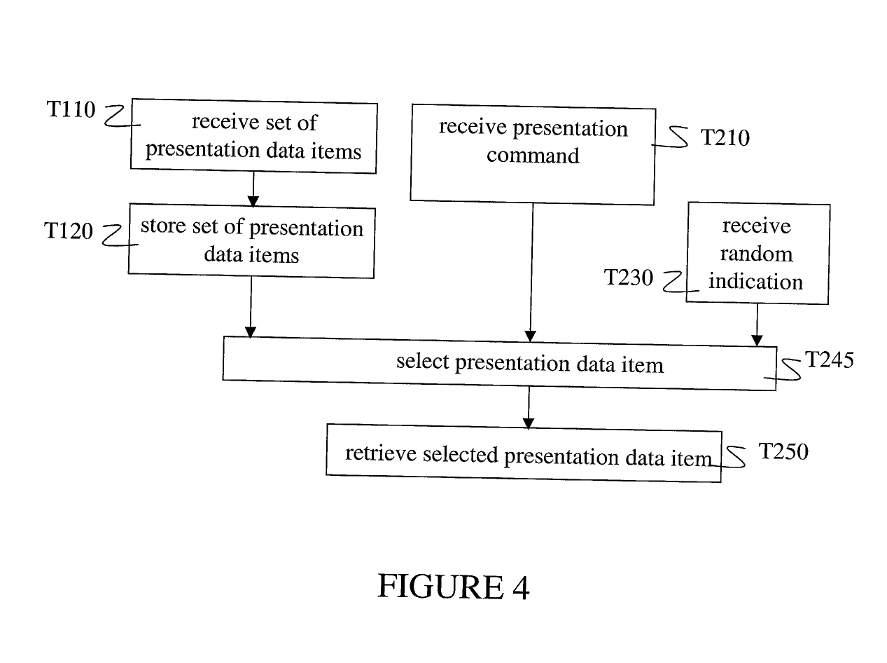

In a further application, retrieval of PDIs may occur on a random rather than a sequential basis. FIG. 3 shows a flowchart of a method according to an embodiment of the invention in which task T230 receives a random indication (e.g. a randomly generated number), and selection task T245 selects a PDI based on the random indication. FIG. 4 shows a flowchart of another method according to an embodiment of the invention in which the first wireless data link is carried over a different wireless channel than the second wireless data link. In these cases, it may be desirable to maintain a presentation history of a different form to indicate which PDIs have been retrieved.

For example, a flag may be associated with each PDI (or PDI block) in the stored set. When a PDI is first stored, the flag is initialized. Upon each retrieval of a PDI, the corresponding flag is updated. In such a case, selection task T245 may choose randomly from among PDIs that have not yet been retrieved or have been retrieved fewer times than other PDIs in the stored set. When all of the PDIs have been retrieved, an action as described above (e.g. to obtain additional PDIs) may be triggered. Alternatively, such a method may provide for multiple retrievals of one or more of the PDIs, such that the action is triggered when the value of one or more of the flags reaches or exceeds a predetermined threshold.

In addition to supporting selection task T240 (and some forms of selection task T245), the presentation history may also be used to indicate which PDIs were presented. Information relating to the presentation of PDIs (also called ‘impression’ information) may also be accumulated directly. Such information may be useful for purposes of billing advertisers on a per-impression basis.

More than one set of PDIs may be stored. For example, several circular queues may be stored, each queue having a separate presentation history. In an exemplary implementation, each queue stores PDIs relating to a particular category. In such an implementation, updates may be performed separately on each queue according to their relative degrees of use. In one application, one or more queues are ordered by priority, such that PDIs in a higher priority queue will be displayed more frequently than PDIs in a lower priority queue. A multi-set implementation may also provide a mechanism for collecting impression and pattern-of-use information. The separate presentation histories may also be used to initiate and/or to guide a decision regarding allocation of storage area among the several queues.

In one example, a queue is provided for such often-used items such as navigational icons (e.g. arrows) and commercial logos of the primary service provider. Although the data items in this queue may be used more often than others, this queue may be updated less frequently than the others, if at all. For example, the queue may be updated only upon a service provider's initiation rather than according to a presentation history. A set of such PDIs may also be loaded into the phone before delivery to the end user or during provisioning (e.g. over-the-air service provisioning or ‘OTASP’). Alternatively, such a set may be loaded by the end user (e.g. over a wired or wireless data link) as a personalized ‘skin.’

Maintenance of several queues may provide another mechanism for a nonexclusive association of presentation commands to PDIs. In a method according to an embodiment of the invention that implements such a mechanism, a presentation command indicates a particular queue by order (e.g. according to an ordering by priority, complexity, storage size, or display size) or by other category.

As the stored PDIs are retrieved for display, or as time passes and they become out of date, it may be desirable at some point to update some or all of the PDIs. For example, all of the stored PDIs may be replaced, a predetermined subset of PDIs may be replaced, or a predetermined section of the storage area may be refreshed. For example, PDIs stored in a first portion of the storage area may be replaced during a first refresh period, and PDIs stored in other portions of the storage area may be replaced during subsequent refresh periods, in a scheme that repeats after the data items stored in the last portion of the storage area have been replaced.

It may be desirable to schedule refresh periods to occur in the evening or during another low-usage period. One advantage to transferring PDIs at such a time is that because bandwidth usage is usually lower, unused capacity (which might otherwise be wasted) may be available. During such periods, the PDIs may even be transferred over the same wireless channel that would be used to transfer a document (e.g. a web page) at another time. In an exemplary application, refresh occurs while the wireless device (e.g. a cellular telephone or PDA having online capability) is being charged.

Alternatively, a refresh period may occur over such a channel any time that the second wireless data link is not active. In such a case, the refresh activity may terminate upon user activation of a browser or of the wireless device upon which the browser executes (e.g. to initiate online activity).

In a particular implementation, PDIs may be transferred over a wireless channel that is a broadcast channel, i.e. a channel that requires only one transmission and may be received by many users at once. In this case, a decision as to which PDIs to replace and/or which portions of a storage area to refresh may be made locally.

In another application, a PDI replacement scheme may be based on the presentation history. For example, the presentation history (possibly together with other information, such as a base marker value) may indicate the number of PDIs (or blocks of PDIs) retrieved since the last update, or the amount of storage space available for new PDIs (e.g. storage space occupied by PDIs that have already been viewed a predetermined number of times). When the presentation history reaches a predetermined value, a request for more PDIs may be initiated. Alternatively, information such as the value of the presentation history may be presented to another entity (e.g. a server) for such determination.

Portions of the stored set or of the storage area may be updated separably according to a criterion such as a schedule. In one such implementation, a predetermined function maps an indication of time information (such as date or GPS time-of-day) to different portions of the stored set or of the storage area (e.g. via a modulo operation), thereby providing an unambiguous indication of which portion is scheduled to be updated in a particular occurrence of the refresh period.

One possible advantage of an application of a method as described herein is simplification of cost accounting. In conventional wireless browsing, separating non-billable airtime (i.e. airtime used to download advertisements) from billable airtime may require tracking and sorting the IP addresses relating to all document and data items transferred. An application that separates the period used to transfer the PDIs from the period used for other purposes (such as to transfer a web page at a user's request) may greatly facilitate cost accounting. By diverting data traffic due to downloading advertisements to off-peak periods, such an application may also help to reduce network congestion during peak usage periods.

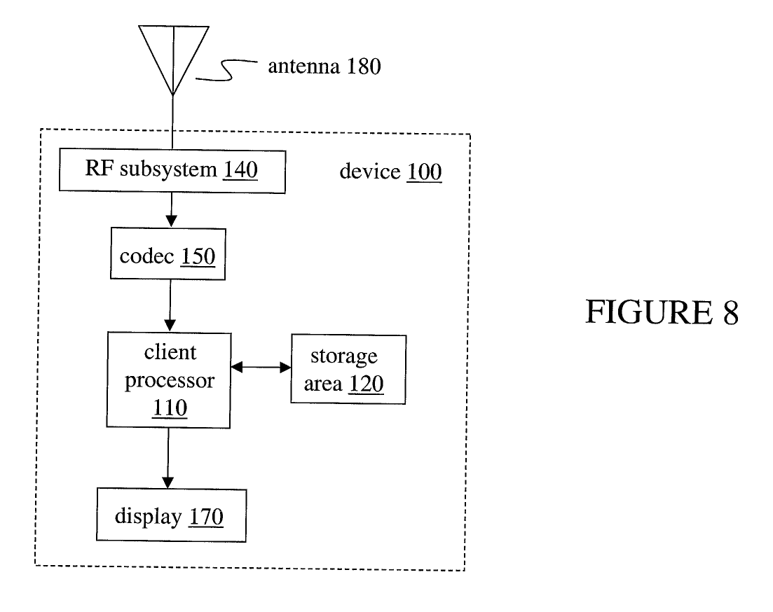

FIG. 8 shows a device 100 for wireless communications that includes a client processor 110 according to an embodiment of the invention. Modulated radio frequency (RF) signals received by one or more antennas 180 are converted to baseband digital data signals in RF subsystem 140. RF subsystem 140 also converts baseband digital data signals into RF signals for transmission through the one or more antennas 180. In coder/decoder (codec) 150, the baseband signals are processed to recover the data content, which processing may include any of a number of demodulation and decoding techniques such as deinterleaving, decoding error detecting/correcting codes, and/or removing digital modulation layers such as spreading codes. Codec 150 also encodes data into base band signals to be provided to RF subsystem 140 for transmission. The encoding functions of codec 150 may include any of a number of modulation and encoding techniques such as interleaving, encoding error detecting/correcting codes, and/or digital modulation using spreading codes. RF subsystem 140 may include a receiver (not shown) that is separate from a transmitter (not shown). Alternatively, the receiver (not shown) may be integrated together with the transmitter (not shown). Similarly, codec 150 may include an encoder (not shown) that is separate from a decoder (not shown). Alternatively, the encoder (not shown) may be integrated together with the decoder (not shown).

In an exemplary application, device 100 receives a set of PDIs over a first wireless data link, and client processor 110 stores the received set in storage area 120. Storage area 120 may be implemented as a fixed or removable storage device or medium. For example, storage area 120 may reside on a semiconductor, flash, or ferromagnetic memory device integrated into an application-specific integrated circuit (ASIC) or into a printed circuit board or other assembly. Alternatively, storage area 120 may reside on a socketed or otherwise removable memory device. For example, such a device may be included within a ‘smart card’ (such as a GSM SIM card), a PCMCIA card, or another memory unit such as a CompactFlash, MemoryStick, or SmartMedia card.

Storage area 120 may reside on a volatile (e.g. CMOS) or non-volatile (e.g. flash) memory device. Such a device may be a separate storage device, or other information such as user data and/or machine-executable instructions (such as code defining, configuring, or otherwise relating to client processor 110, codec 150, and/or other operations or tasks of device 100) may also reside on the memory device. Presentation history(ies) 130 may reside with storage area 120 and/or may reside with code or data storage that is associated with client processor 110 or another operation or task of device 100.

On one hand, the amount of storage area required to store the set of PDIs may be limited by the amount of time and bandwidth available for transferring PDIs, as it may be impractical to provide a capacity larger than the amount of data expected to be available. On the other hand, the amount of storage area provided for storage of PDIs may also depend on factors such as hardware cost, acceptability or frequency of PDI reuse, and desired presentation quality for the PDI upon display (or other presentation such as audio).

Over a second wireless data link, device 100 receives a presentation command (e.g. as part of a web page or other document as described above) as stored in storage area 120. Client processor 110 selects and retrieves a PDI from storage area 120 (e.g. according to selection and retrieval tasks as described above) and forwards the PDI to a display 170. Display 170 may include a liquid-crystal display (LCD) screen and associated driver hardware. Display 170 may also include software and/or firmware (e.g. display processing logic such as a JPG or GIF decoder) to convert the PDI to a displayable form and/or to configure the screen display (e.g. in response to additional information received by client processor 110). In another application, client processor 110 forwards the retrieved PDI to a sound reproduction device (e.g. including an audio amplifier and an audio transducer such as a speaker or earphone, possibly together with audio processing logic).

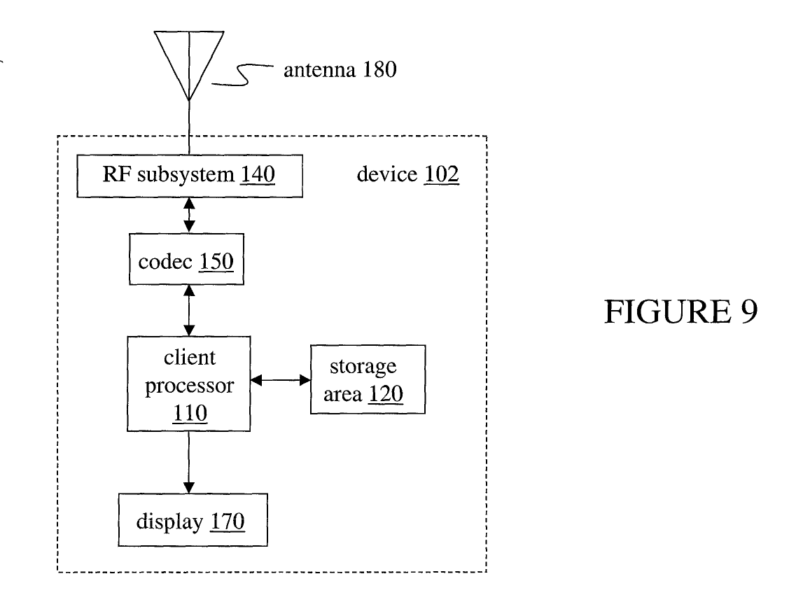

FIG. 9 shows an implementation 102 of device 100 in which client processor 110 transmits information via codec 150, RF/IF subsystem 140, and antenna(s) 180. For example, client processor 110 may perform tasks associated with a browser, including transmitting HTTP requests. In one such application, client processor 110 receives the set of PDIs via an HTTP POST transaction. Client processor 110 may also transmit information on PDI use (e.g. presentation history information as described above). Such information may be used for cost accounting and/or for scheduling or configuring refresh operations. For example, an advertiser might be charged at a rate that is based on how many times a PDI containing a particular advertisement is retrieved or displayed.

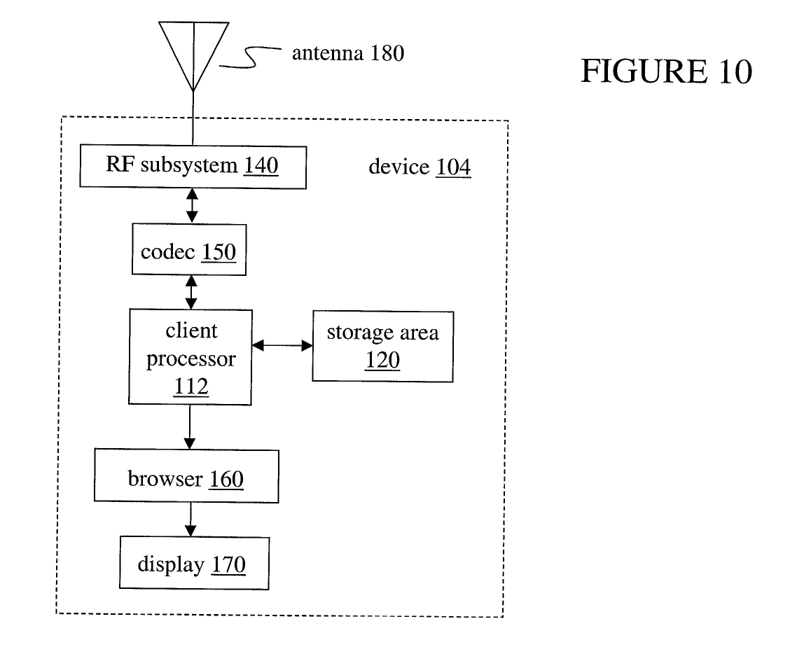

FIG. 10 shows an implementation 104 of device 100 including a browser 160. Browser 160 receives user input and forwards presentation data and configuration information to display 170 to support online browsing activity. In this case, client processor 112 intercepts a received set of PDIs and stores the set to storage area 120. Client processor 112 also filters requests outputted by browser 160 as described above (e.g. intercepting requests associated with URIs within a particular range). Client processor 112 selects and retrieves a PDI according to the request and based on a presentation history (or a random indication) and forwards the PDI to browser 160 in response to the request. In such an application, information such as user data and/or machine-executable instructions defining, configuring, or otherwise relating to browser 160 may also reside on the memory device on which storage area 120 resides.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a wireless device. In the alternative, the processor and the storage medium may reside as discrete components in a user terminal.

Thus, the foregoing presentation of the described embodiments is provided to enable any person skilled in the art to make or use the present invention. Various modifications to these embodiments are possible, and the generic principles presented herein may be applied to other embodiments as well. For example, the invention may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit. Thus, the present invention is not intended to be limited to the embodiments shown above but rather is to be accorded the widest scope consistent with the principles and novel features disclosed in any fashion herein.

What is claimed is:

1. A method of data selection comprising:
receiving at least one presentation data item over a first wireless data link;
receiving over a second wireless data link a presentation command;
selecting, in response to the presentation command, a selected presentation data item from the at least one presentation data item; and
presenting the selected presentation data item.

2. The method of data selection according to claim 1 further comprising initiating the first wireless data link during a low-usage period.

3. The method of data selection according to claim 1, wherein the first wireless data link is carried over a first wireless channel using a first destination address and the second wireless data link is carried over second wireless channel using a second destination address, and wherein the first destination address is different from the second destination address.

4. The method of data selection according to claim 3, wherein the first wireless channel is a broadcast channel.

5. The method of data selection according to claim 1, wherein said selected presentation data item is selected at random from the at least one presentation data item.

6. The method of data selection according to claim 1, wherein the at least one presentation data item includes image data.

7. The method of data selection according to claim 1, wherein the presentation command includes a Uniform Resource Identifier.

8. The method of data selection according to claim 7, wherein the Uniform Resource Identifier is included in a ‘src’ attribute of a web page markup language.

9. The method of data selection according to claim 7, wherein the Uniform Resource Identifier is included in a ‘src’ property of an Image object of a Javascript routine.

10. The method of data selection according to claim 1, wherein the presentation command includes a Uniform Resource Identifier.

11. The method of data selection according to claim 1, wherein the presentation command is indicative of a remotely stored presentation data item, the method further comprising replacing the presentation command with a replacement command indicative of a locally stored presentation data item.

12. The method of data selection according to claim 1, wherein the presentation command is indicative of a remotely stored presentation data item, and wherein said selected presentation data item is stored locally.

13. The method of data selection according to claim 1 further comprising updating a presentation history based on said presenting.

14. The method of data selection according to claim 1, wherein said selecting is based on a presentation history, the method further comprising transmitting information based on the presentation history to a wireless network.

15. The method of data selection according to claim 1, wherein each of the at least one presentation data item is associated with at least one of a plurality of categories, and wherein the presentation command includes a command category indicative of one of the plurality of categories, the method further comprising comparing the command category with categories associated with the at least one presentation data item, and wherein said selecting is based on said comparing.

16. An apparatus for data selection and presentation comprising:
means for receiving at least one presentation data item over a first wireless data link;
means for receiving over a second wireless data link a presentation command;
means for selecting, in response to the presentation command, a selected presentation data item from the at least one presentation data item; and
means for presenting the selected presentation data item.

17. A computer readable medium embodying method for data selection and presentation, the method comprising:
receiving at least one presentation data item over a first wireless data link;
receiving over a second wireless data link a presentation command;
selecting, in response to the presentation command, a selected presentation data item from the at least one presentation data item; and
presenting the selected presentation data item.

18. A method of data selection comprising:
receiving at least one presentation data item over a first wireless data link;
detecting a subsequent local event;
selecting, in response to the subsequent local event, a selected presentation data item from the at least one presentation data item.

19. The method of claim 18, wherein said subsequent local event is the receipt of input from a user.

20. The method of claim 18, wherein said subsequent local event is the expiration of a period during which a previous presentation data item has been presented.

21. The method of claim 18, wherein said subsequent local event is a powering on of a wireless device.

22. The method of claim 18, wherein said subsequent local event is activating a wireless device.

23. An apparatus for data selection and presentation comprising:
means for receiving at least one presentation data item over a first wireless data link;
means for detecting a subsequent local event;
means for selecting, in response to the subsequent local event, a selected presentation data item from the at least one presentation data item.

24. A computer readable medium embodying a method for data selection and presentation, the method comprising:
receiving at least one presentation data item over a first wireless data link;
detecting a subsequent local event;
selecting, in response to the subsequent local event, a selected presentation data item from the at least one presentation data item.

25. A method of data transmission, said method comprising:
transmitting at least one presentation data item over at least one first wireless data link; and
transmitting a presentation command over a second wireless data link, wherein the at least one first wireless data link is carried over at least one first wireless channel, and wherein the second wireless data link is carried over a second wireless channel different from the first wireless channel.

26. The method of data transmission according to claim 25, wherein the at least one first wireless channel and second wireless channel are established in different code spaces.

27. The method of data transmission according to claim 25, wherein the at least one first wireless channel includes a broadcast channel.

28. The method of data transmission according to claim 25 further comprising receiving a presentation history indicative of presentation patterns of presentation data items.

29. The method of data transmission according to claim 28 further comprising storing the presentation history.

30. The method of data transmission according to claim 28, wherein said transmitting at least one presentation data item is based on the presentation history.

31. The method of data transmission according to claim 25, wherein each of the at least one presentation data item is associated with at least one of a plurality of categories, and wherein the presentation command is indicative of a category with which the selected presentation data item is associated.

32. The method of data transmission according to claim 25, wherein said transmitting at least one presentation data item occurs according to a schedule, and wherein said transmitting a presentation command occurs in response to a request received over the second wireless data link.

33. A device for wireless communications, said device comprising:
a radio frequency (RF) subsystem configured and arranged to receive at least one presentation data item over a first wireless data link and a presentation command over a second wireless data link;
a storage area configured and arranged to store the at least one presentation data item.
a client processor configured and arranged to select, in response to the presentation command, a selected presentation data item stored in the storage area.

34. The device according to claim 33, wherein the client processor and the storage area are configured and arranged to receive the at least one presentation data item on a broadcast channel.

35. The device according to claim 33, wherein the client processor and the storage area are configured and arranged to receive the at least one presentation data item over the first wireless data link of a first channel type and the presentation command over the second wireless data link of a second channel type, wherein the first channel type is different from the second channel type.

36. The device according to claim 33, wherein the client processor and the storage area are configured and arranged to initiate the first wireless data link during a low usage period.

37. The device for wireless communications according to claim 33, wherein the client processor and the storage area are configured and arranged to select the selected presentation data item at random from the at least one presentation data item stored in the storage area.

38. The device for wireless communications according to claim 33, wherein the presentation command includes a Uniform Resource Identifier.

39. The device for wireless communications according to claim 33, wherein the client processor and storage area are configured and arranged to select the selected presentation data item based on whether a Uniform Resource Identifier within the presentation command falls within a predetermined set of Uniform Resource Identifiers.

40. The device for wireless communications according to claim 33, wherein the client processor and storage area are configured and arranged to select the selected presentation data item based on whether a category indicated by the presentation command corresponds to the selected presentation data item.

41. The device for wireless communications according to claim 40, wherein the client processor and storage area are configured and arranged to intercept a Uniform Resource Identifier within the presentation command based on presentation data items stored within the storage area.

42. The device for wireless communications according to claim 33, wherein the client processor and storage area are configured and arranged to update a presentation history based on previously-selected presentation data items.

43. The device for wireless communications according to claim 42, wherein the client processor and storage area are configured and arranged to provide the presentation history to the RF subsystem for transmission through an antenna.

44. A device for wireless communications, said device comprising:
a radio frequency (RF) subsystem configured and arranged to receive at least one presentation data item over a wireless data link;
a storage area configured and arranged to store the at least one presentation data item.
a client processor configured and arranged to select, in response to a detected local event, a selected presentation data item stored in said storage area.

45. The device of claim 44, wherein the detected local event is the receipt of input from a user.

46. The device of claim 44, wherein the detected local event is the expiration of a period during which a previous presentation data item has been presented.

47. The device of claim 44, wherein the detected local event is a powering on of the device.

48. The device of claim 44, wherein the detected local event is opening the device.
